(19) United States
(12) Patent Application Publication
(10) Pub. No.: US 2010/0050868 A1
(43) Pub. Date: Mar. 4, 2010

(54) MERCURY ABSORPTION USING CHABAZITE SUPPORTED METALLIC NANODOTS

(75) Inventors: Steven Kuznicki, Edmonton (CA); David J.A. Kelly, Edmonton (CA); David Mitlin, Edmonton (CA); Zhenghe Xu, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: GOVERNORS OF THE UNIVERSITY OF ALBERTA, Edmonton, AB (CA)

(21) Appl. No.: 12/518,706

(22) PCT Filed: Dec. 11, 2007
(86) PCT No.: PCT/CA07/02246

§ 371 Date: Nov. 10, 2009

Related U.S. Application Data
(60) Provisional application No. 60/869,474, filed on Dec. 11, 2006.

(51) Int. Cl. B01D 53/64; B01J 20/04

(52) U.S. Cl. 95/134; 502/411; 977/774

(57) ABSTRACT

A method of adsorbing mercury includes the use of silver nanodots formed on chabazite as a sorbent. The silver nanodots may be formed on chabazite by ion-exchange followed by activation.

### FIELD OF THE INVENTION

The present invention relates to a method of adsorption of mercury using metallic nanoparticles formed on chabazite and chabazite analogs, and more particularly silver nanodots.

### BACKGROUND

Mercury emissions from industrial processes, such as coal fired powerplants, are obviously undesirable. Capture of elemental mercury from coal-fired power plant flue gas is extremely difficult if not impossible via conventional controls (Brown et al., 1999) because existing controls are better suited for capture of oxidized mercury species, formed as flue gases cool from furnace temperatures, particularly with eastern bituminous coals. Mercury emissions from Western Canadian coals are primarily elemental mercury (Pavlish et. al., 2005).

World wide, tremendous efforts have been devoted to post-combustion mercury capture using bulk sorbent capture concepts (Miller, 2005). Five classes of novel sorbents, each with advantages and disadvantages, have been identified by Granite et. al., (2000) to be: i) activated carbons and variants; ii) metal oxides; iii) metal sulfides; iv) unburned carbon; and v) noble metals. Among these sorbents, carbon-based sorbents may be the only technology commercially-deployable in the near term (Pavlish et al., 2005).

In general, carbon-based sorbents are not mechanistically well-suited to the capture of elemental mercury (HgO) and significant efforts have been focused on trying to improve this reality. Recent improvements in elemental mercury capture were achieved using bromination (Nelson et al., 2004). However, it should be cautioned that volatile oxides of mercury were released from chlorine-impregnated carbon (Vidic and Siler, 2001). As a result, interactions of the released mercury with flue gas components would have to be assessed (Miller et al., 2000). Controlling combustion conditions to generate unburned carbon on fly ash also shows potential and was recently reviewed by Senior and Johnson (2005). Electrolytic regeneration of carbon sorbents, doped or otherwise, is at the concept stage only, and may never be feasible in the practical power plant environment (Sobral et al., 2000; Erickson, 2002). Separation of mercury from the sorbent waste is not envisioned with these technologies, although the unburned carbon approach may eliminate the need to purchase activated carbon.

It is generally accepted that the drawbacks of existing sorbents include, but are not limited to, an undefined and irreversible capture mechanism, solid waste stream disposal concerns, and the limitations imposed by the elevated temperatures of industrial process gases. A sorbent solution would require either oxidation of mercury to trap on traditional sorbents or a sorbent material that could intercept elemental mercury itself at realistic process gas temperatures.

Many metals are known to amalgamate with mercury, and in particular, silver is known to amalgamate with mercury, and thus may provide a useful mercury scavenger. However, efficient and effective forms of silver in such use have not yet been made. Nanoparticulate silver may provide a useful mercury scavenger, however, the formation of nanoparticulate silver is not without difficulty.

Silver nanodots and their formation have recently been discussed by Metraux and Mirkin (2005). Traditional methods for the production of silver nanodots require use of potentially harmful chemicals such as hydrazine, sodium borohydride and dimethyl formamide (“DMF”). These chemicals pose handling, storage, and transportation risks that add substantial cost and difficulty to the production of silver nanodots. A highly trained production workforce is required, along with costly production facilities outfitted for use with these potentially harmful chemicals.

Another disadvantage of known methods for producing silver nanodots relates to the time and heat required for their production. Known methods of production utilize generally slow kinetics, with the result that reactions take a long period of time. The length of time required may be shortened by some amount by applying heat, but this adds energy costs, equipment needs, and otherwise complicates the process. Known methods generally require reaction for 20 or more hours at elevated temperatures of 60°-80° C., for example. The relatively slow kinetics of known reactions also results in an undesirably large particle size distribution and relatively low conversion. The multiple stages of production, long reaction times at elevated temperatures, relatively low conversion, and high particle size distribution of known methods make them costly and cumbersome, particularly when practiced on a commercial scale.

While silver ensembles are well known to form within zeolite cavities under certain conditions, and much larger configurations often form freely on zeolite surfaces, nanodots have not been known to form on zeolite surfaces.

These and other problems with presently known methods for making silver nanodots are exacerbated bythrough the relatively unstable nature of the nanodots. Using presently known methods, silver nanodots produced have only a short shelf life since they tend to quickly agglomerate.

Therefore, there is a need in the art for a convenient and inexpensive method of forming metal nanodots, such as silver nanodots, which mitigates the difficulties of the prior art.

### SUMMARY OF THE INVENTION

In one aspect, the invention comprises a sorbent for scavenging mercury emissions from an industrial process, and methods of using and forming such sorbents. In one aspect, the sorbent comprises metal nanoparticles on a chabazite surface. Preferably, the metal nanoparticles comprise silver nanodots. In one embodiment, the composition is formed by silver ion-exchange with the chabazite, followed by activation at moderate temperatures. In one embodiment, the chabazite may comprise natural chabazite, an upgraded, semi-synthetic, or synthetic chabazite, or analogues thereof. In one embodiment, the metal may comprise a transition or noble metal, for example, copper, nickel, palladium or silver.

In one embodiment, silver is a preferred metal. In one embodiment, silver nanodots may form having diameters less than about 100 nm, for example, less than about 50 nm, 30 nm, 20 nm, or 10 nm. In one embodiment, the nanodots are in the order of about 1 to about 5 nm, with a mean of about 3 nm. The nanodots may form under a wide range of conditions on chabazite surfaces. In our testing, these nanodots are stable to at least 500° C. on the chabazite surfaces and remain as uniform nanodots under prolonged heating at elevated temperatures. Twenty (20%) weight percent by weight, or more, of a zeolite metal nanoparticle composite material may be composed of these silver particles.

The composition of the present invention is distinctly different from the well established science of growing metal nanodots or nanowires within a zeolite cage framework, thus producing nanostructures inside the material (Ackley, 2003; Bruhweiler, 2004; Lewis, 1993; Mondale, 1995). In the present invention, unlike in the prior art, the metallic nanodots are surface-accessible on the zeolite support.

Nanostructured silver materials produced in accordance with the present invention may have many useful properties. In one aspect, the invention may comprise the use of nanodots of silver, which were formed on chabazite, to reversibly adsorb mercury at high temperatures.

Therefore, the invention may be generally contemplated as a method of adsorbing mercury emissions from an industrial process stream, comprising the step of exposing the process stream to a composition comprising a metal nanoparticle material. Preferably, the metal nanoparticles comprise silver nanodots formed on a chabazite material. In one embodiment, the silver nanodot material is formed by (a) performing ion-exchange with a solution of the metal ions and a chabazite material; and (b) activating the ion-exchanged chabazite material.

In another aspect, the invention may comprise a mercury sorbent composition comprising chabazite supported metal nanoparticulate material, comprising surface-accessible particles of metal, having a substantially uniform particle size less than about 100 nm, for example, less than about 50 nm, 30 nm, 20 nm, or 10 nm. In one embodiment, the material may comprise silver nanodots having a diameter less than about 5 nm.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIGS. 1A, 1B and 1C show XPS spectra of silver, aluminum, and sodium respectively, in untreated and silver ion-exchanged chabazite.

FIGS. 2A and 2B show annular dark-field STEM micrographs of silver nanodots residing on the surface of the chabazite support. FIG. 2A shows a low-magnification image showing overall Ag dispersion. FIG. 2B is a higher magnification image illustrating the size of the individual nanodots. FIG. 2C shows a particle diameter distribution of the silver nanodots shown in FIG. 2B.

FIG. 3 shows a scanning Auger microscope mapping silver distribution on the chabazite surface.

FIG. 4 shows elemental mercury breakthrough on silver nanodots covered chabazite, compared with mercury breakthrough using untreated chabazite.

FIG. 5 shows annular dark field STEM micrographs of silver nanodots on raw chabazite, and silver nanodots on aluminum enriched chabazite analog.

FIG. 6A shows powder X-ray diffraction spectra for raw chabazite and FIG. 6B for upgraded semi-synthetic chabazite.

FIG. 7 shows mercury capture (ppb wt) by a range of sorbents following 5 minutes exposure in the flue gases of an operating Rankine Cycle coal-fired power plant.

FIG. 8 shows a performance comparison of bulk silver metal and nanosilver zeolite as measured by percent breakthrough at given temperatures.

FIG. 9 shows a performance comparison of nanosilver zeolite before and after a 5 minute in situ exposure to the Genesee G1/G2 Coal-fired Power Plant flue gas, measured by percent breakthrough at the given sorbent temperature.

### DETAILED DESCRIPTION OF PREFERRED EMBODIMENTS

The present invention relates to metallic silver nanodots formed on chabazite or a chabazite-like material and its use in adsorbing mercury from an industrial process stream, such as emissions from a coal-fired power plant. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

Although consistent terminology has yet to emerge, those skilled in the art generally consider “nanoclusters” to refer to smaller aggregations of less than about 20 atoms. “Nanodots” generally refer to aggregations having a size of about 10 nm or less. “Nanoparticles” are generally considered larger than nanodots, up to about 200 nm in size. In this specification, the term “nanodots” shall be used but is not intended to be a size-limiting nomenclature, and thus may be inclusive of nanoclusters and nanoparticles.

The term “about” shall indicate a range of values ±10%, or preferably ±5%, or it may indicate the variances inherent in the methods or devices used to measure the value.

As used herein, “chabazite” includes mineral chabazite, synthetic chabazite analogs such as zeolite D, R, G and ZK-14, and any other material with a structure similar or related to mineral chabazite. Chabazite and chabazite-like structures comprise a family of tectosilicate zeolitic materials (K. A. Thrush et al., 1991) ranging from relatively high silica to stoichiometric 1:1 silica/aluminum materials. Synthetic analogs may be derived from any aluminosilicate source, such as kaolin clay. Thus, chabazite may include high-aluminum analogs such as those described in U.S. Pat. No. 6,413,492, the contents of which are incorporated herein by reference. Mineral chabazite may be upgraded such as by the methods described in Kuznicki et al “Chemical Upgrading of Sedimentary Na-Chabazite from Bowie, AZ”, Clays and Clay Min. June 2007, 55:3, 235-238. One example of chabazite is exemplified by the formula: (Ca,Na₂,K₂,Mg)Al₂Si₄O₁₂.6H₂O. Recognized varieties include, but may not be limited to, Chabazite-Ca, Chabazite-K, Chabazite-Na, and Chabazite-Sr depending on the prominence of the indicated cation. Chabazite crystallizes in the trigonal crystal system with typically rhombohedral shaped crystals that are pseudo-cubic. The crystals are typically but not necessarily twinned, and both contact twinning and penetration twinning may be observed. They may be colorless, white, orange, brown, pink, green, or yellow. Chabazite is known to have more highly polarized surfaces than other natural and synthetic zeolites.

In general terms, in one embodiment, metal nanodots may be formed on a chabazite surface by ion-exchange of the metal cation into the chabazite, followed by an activating step, resulting in the formation of metal nanodots. In one embodiment, the metal is one of silver, copper, nickel, gold or a member of the platinum group. As used herein, a “platinum group” metal is ruthenium, rhodium, palladium, osmium, iridium or platinum. Generally, silver, gold and the platinum group are self-reducing. The use of salts of these metals will generally result in the formation of metal nanodots without the imposition of reducing conditions. However, the use of reducing conditions for such metals is preferable, if only to minimize oxidation of the metal. Generally, copper and nickel are reducible and their salts will generally result in the formation of metal nanodots upon reduction in a reducing atmosphere.

In a preferred embodiment, the metal comprises silver or nickel.

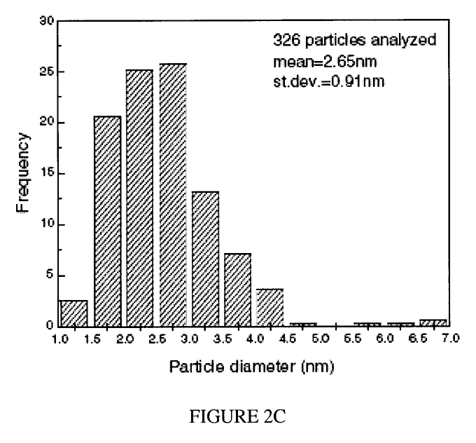

In one embodiment, silver nanodot chabazite may be prepared by ion-exchange of chabazite samples. For example, in one embodiment, chabazite as a fine powder (200 mesh) may be exposed to an excess of aqueous silver nitrate. In one embodiment, ion-exchange takes place at room temperature with stirring for 1 hour. The material may then be washed and dried. The silver ions in the zeolite may then be converted to metallic silver nanodots, supported on the chabazite, by an activation step. In one embodiment, the activation step may simply comprise the step of drying the material at room temperature. In a preferred embodiment, the activation step may comprise annealing the material at an elevated temperature, such as from 75° C. to 500° C. or higher, and preferably between about 100° to about 400° C. The activation step may take from 1 to 4 hours, or longer. In one embodiment, the activating step is performed, for example, in a reducing environment. In one embodiment, the nanodots have a size less than about 100 nm, for example less than about 50 nm, less than about 30 nm or less than about 20 nm. In one embodiment, a substantial majority of the metal nanodots formed will have a particle size of less than about 10 nm. In one preferred embodiment, a substantial majority is seen to, i.e. the nanodots will not have a dimension greater than about 10 nm, and preferably a majority of the particles will be less than about 5 nm. In a preferred embodiment, the particles have a size distribution similar to that shown in FIG. 2C, with a mean particle size less than about 3 nm.

In general, the size of the nanodots appears to be influenced by reducing or oxidizing conditions of the activating step. In one embodiment, the use of reducing conditions results in generally smaller nanodot sizes. Conversely, the use of mild oxidizing conditions, such as air, results in generally larger nanodot sizes.

Without being restricted to a theory, it is believed that the activating process causes the silver ions to migrate to the surface of the chabazite and, where they reside as nanodots rather than as large particles or sheets. The silver ions reduce to their metallic state, before or after nanodot formation. Although the exact mechanism of the nanodot formation is not known, their scale and uniform distribution are likely due, at least in part, to the unusually highly polarized chabazite surface relative to other natural and synthetic zeolites (Baerlocher, 2001; Breck, 1974; Hayhurst, 1978). As a result, the chabazite surface may have a significant electronic interaction with the nanodots. This may stabilize particles containing a specific number of atoms (electronic charge consideration) or that are located at specific regions of the substrate, such as at steps or at kinks. Another rate limiting step may actually be the surface diffusion of the silver atoms, which is also affected by the charge. It may be that once the silver has migrated from the chabazite interior onto the surface, it becomes essentially “locked-in”, able to neither diffuse back into the bulk nor migrate over the surface to join the larger clusters. An additional factor that will promote nanodot stability is the narrowness of the observed size distribution, which will reduce the driving force for Ostwald ripening.

In one embodiment, the chabazite comprises chabazite having significant gross plating morphology or exterior surface area. Without restriction to a theory, it is believed that the greater exterior surface area of certain chabazites, permits silver aggregations to form without agglomerating into larger particles. The greater surface area permits a large number of smaller aggregations to remain isolated from each other, and facilitate nanodot formation. In general, less crystalline chabazite having larger gross plating morphology or exterior surface area is more conducive to nanodot formation. In one embodiment, the chabazite presents gross plating morphology or exterior surface area of greater than about 5 m²/g. In a preferred embodiment, the chabazite has an exterior surface area greater than about 10 m²/g, and more preferably greater than about 15 m²/g. In one preferred embodiment, the chabazite comprises chabazite having the characteristics of sodium chabazite originating from Bowie, Ariz.

In a preferred embodiment, chemically upgraded chabazite may facilitate the formation of metallic nanodots, or may induce more uniform metallic nanodots at higher concentrations. While samples of large crystals of essentially pure chabazite are well known (for example from Wasson Bluff, Nova Scotia, Canada), large, commercially exploitable deposits, like those found at Bowie, Ariz., the chabazite is typically co-formed with significant amounts of other natural zeolites such as clinoptilolite and erionite.

It is known that raw sodium Bowie chabazite ore can be recrystallized by caustic digestion into an aluminum-rich version of the chabazite structure with a Si/Al ratio that can approach 1.0 (Kuznicki, 1988). The more siliceous phases of the chabazite ore, clinoptilolite and erionite, selectively dissolve in the alkaline medium, reforming with the chabazite as an apparent template. Such semi-synthetic high aluminum chabazite analogs manifest an increase in cation exchange capacity, such as greater than about 5 meq/g and (to as high as about 7.0 meq/g,) and demonstrate high selectivity towards heavy metals from solution, especially lead (Kuznicki, 1991). However, these aluminum-rich materials are unstable toward rigorous dehydration and therefore are not preferred as as selective gas adsorbents.

Therefore, in one embodiment, sodium chabazite ore, such as that originating in the Bowie deposit, may be reformed and upgraded in an alkaline medium to a semi-synthetic purified, upgraded chabazite with elemental compositions resembling the original chabazite component of the ore (Si/Al ˜of about 3.0-3.5) if substantial excess soluble silica is present in the reaction/digestion medium. In this process, essentially all of the clinoptilolite and much of the erionite is dissolved and reformed into chabazite, but not at the high aluminum content produced by solely caustic digestion. This novel, semi-synthetic, purified and upgraded chabazite is stable towards the rigorous dehydration needed to activate it as an adsorbent. Also, if the process is conducted on granules of the chabazite ore (which are of generally poor mechanical strength) the granules gain greatly in mechanical strength as the clinoptilolite and erionite, which are recrystallized into chabazite, appear to bind the edges of the existing chabazite platelets.

These more uniform, upgraded semi-synthetic chabazites show an enhanced propensity to form uniform dispersions of metal nanodots (such as silver) on their surfaces compared to the raw chabazite ore from which they are derived. In addition, they appear to have enhanced adsorbent properties for molecules such as water and form stronger acid sites (in the H form).

The novel metallic nanodots supported on chabazite may have many possible uses which exploit the macro and nano properties of the metallic element. In one embodiment of a silver nanoparticulate material, they may be used to adsorb mercury from a process stream, such as elemental mercury from coal-fired power plant flue gas.

### EXAMPLES

### Example 1

### Chabazite

Sedimentary chabazite from the well-known deposit at Bowie, Ariz. was utilized as the zeolite support, obtained from GSA Resources of Tucson, Ariz. (http://gsaresources.com). Aluminum enriched chabazites were prepared by prolonged digestion of the raw ore in alkaline silicate mixtures for 1-3 days at 80° C. The degree of aluminum enrichment was governed by the amount of excess alkalinity available during the digestion and recrystallization process.

Phase identification of chabazite and aluminum enriched analogs was conducted by X-ray diffraction analysis using a Rigaku Geigerflex Model 2173 diffractometer unit. As is typical of samples from the Bowie deposit, XRD analysis indicated that the material was highly zeolitized with chabazite being the dominant phase. The material also contained significant clinoptilolite and erionite as contaminants as seen in FIG. 6A. Caustic digested enhanced or aluminum enriched materials were found to gain intensity for the chabazite-like peaks while losing all clinoptilolite and a substantial portion of the erionite during the upgrading process, as can be seen by comparing FIGS. 6A and 6B.

### Example 2

### Formation of Silver Nanodots

Silver ion-exchange was accomplished by exposure of the chabazite as 200 mesh powders to an excess of aqueous silver nitrate at room temperature with stirring for 1 hour. The exchanged materials were thoroughly washed with deionized water, and dried at 100° C. To convert the silver ions in the zeolite to supported metallic silver nanoparticles, the ion-exchanged chabazite was activated at temperatures ranging from 150° C. to 450° C., for periods of 1-4 h in air.

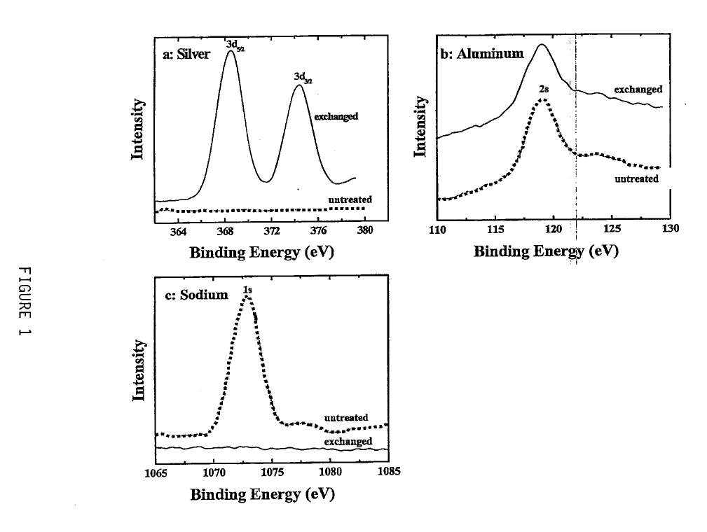

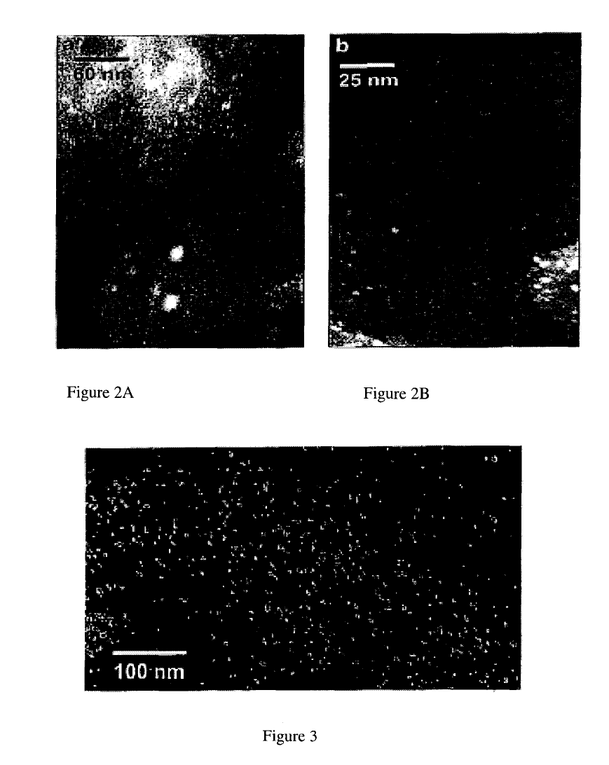

Successful ion exchange was confirmed by x-ray photoelectron spectroscopy (XPS). FIGS. 1A-1C show the intensity (given in arbitrary units) versus binding energy XPS spectra for the untreated (dotted line) and the ion-exchanged (solid-line) chabazite. An intensity shift between the two spectra was added to separate the peaks which would otherwise overlap. As shown by the spectra in FIG. 1A, silver is present on the surface of the silver-exchanged chabazite but is absent on the surface of the untreated chabazite. The binding energy of 3d_{5/2} photon electrons confirms that the silver is in its metallic state.

To examine the extent of silver ion exchange with sodium, the narrow spectra of aluminum and sodium were also acquired. These are shown in FIGS. 1B and 1C. Both the original and the ion-exchanged chabazite exhibited a similar aluminum spectrum in both band positions and peak intensity. From FIG. 1C, it is evident that within the detection limit of XPS, the ion exchange of sodium by silver on the chabazite is complete. This is indicated by the absence of a sodium band on the spectrum of silver exchanged material

Semi-quantitative elemental analysis of the material surfaces was conducted by XPS utilizing a Kratos AXIS 165 spectrometer using monochromated Al Kα (hv=1486.6 eV) radiation in fixed analyser transmission (FAT) mode. The pressure in the sample analysis chamber was less than 10⁻⁷ Pa (10⁻⁹ torr). Powder samples were mounted on stainless steel sample holders using double-sided adhesive tape. Pass energies of 160 eV and 20 eV were used for acquiring survey and high resolution narrow scan spectra, respectively. An electron flood gun was used to compensate for static charging of the sample. The binding energies of the spectra presented here are referenced to the position of the C 1s peak at 284.5 eV. Data acquisition and peak fitting were performed by CASA-XPS software.

Transmission electron microscopy (TEM) analysis was used to investigate the silver metal nanodots in the post-reduction samples. FIG. 2 illustrates the silver distribution on the chabazite samples. TEM was performed on a Philips Tecnai F20 Twin FEG, equipped with EDX, EFTEM/EELS, Annular Dark field Detector (ADF), and high angle tilting capability, located at the University of Calgary. The microscope was operated in scanning transmission (STEM) mode. Samples were prepared by dry grinding and dry dispersing materials onto copper grids. Quantitative particle size analysis was performed using SPIP™ microscopy image processing software.

Using STEM, the silver nanodots, which are denser than the chabazite substrate, appear bright. FIG. 2A shows a low magnification image illustrating the general uniformity of the distributed silver (white regions). FIG. 2B is a higher magnification image, illustrating the ultra-fine size of the silver nanodots. Quantitative particle size analysis reveals that the vast majority of the silver nanoparticles are in the order of about 1 to about 5 nm in diameter, with a mean of 2.6 nm. As seen in FIG. 2B, higher magnification appears to show the silver as spherical nanodots resting on the chabazite surfaces, although other globular morphologies can not be excluded. The distribution of silver is generally homogeneous, although there are occasional regions in the microstructure that have an irregular particle size and spacing, including some apparent larger pools of metal. This may be due to irregularities in the composition of the mineral substrate.

The nanodot composition was confirmed as essentially pure silver using ultra-fine probe energy dispersive X-ray spectroscopy (EDXS) analysis. The binding energy of the 3d_{5/2} photon electrons in the XPS spectrum confirms that silver is predominantly in the metallic state. Besides silver, the particles also contain trace amounts of aluminum and iron, although we were unable to quantify them. Due to the technique employed, it is also possible that other contaminants such as Na, C, Al and Si may be present in small amounts though we were unable to obtain the exact compositions.

Both XPS and ICP-MS indicated a silver loading on the order of 20-21 wt. %. Also, there was essentially a complete lack of sodium which would be expected with quantitative exchange. The chabazite platelets are so thin that bulk and surface analyses may be viewing the same portion of the sample and equivalent analyses might be expected. A silver content of slightly in excess of 20 wt. % of the total sample is consistent with the ˜2.5 mequiv/g exchange capacity expected for this material.

### Example 3

### Auger Microscopy

Auger microscopy was performed by a JEOL JAMP-9500F Field Emission Scanning Auger Microprobe. The instrument was equipped with a field-emission electron gun and hemispherical energy analyzer. Identically prepared powders were used for the microprobe analysis as for the TEM.

FIG. 3 shows a scanning Auger microprobe image of the Ag distribution on the chabazite surface. The silver particles appear slightly larger in the microprobe images relative to the TEM-obtained results. Their distribution also appears less dense. The number density difference may be attributed to the fact that a TEM image shows a minimum of two surfaces (chabazite is a finely layered structure where there are likely more than two surfaces present in each electron transparent sample), while an Auger image simply shows the top surface. The larger apparent particle size may be partly due to the inferior spatial and analytical resolution of the microprobe relative to the TEM, since out-of-focus particles appear larger, while sufficiently fine clusters go undetected. We should also note that it may be physically possible to grow the smaller metal clusters shown in TEM images within the chabazite, despite a known 0.38 nm×0.38 nm channel geometry {3D} and a 0.43 nm kinetic pore diameter (Breck, 1974; Baerlocher, 2001; Hayhurst, 1978). In other systems, this has been attributed to the formation of nanoaggregates consisting of several interconnected assemblies of supercage size (Seidel, 1999), or due to local destruction of the lattice (Carvill, 1993). Thus some of the smaller particles observed in the TEM may be still located inside the cages and would not be detected by Auger. However, the Auger results do indicate that a significant fraction of the silver is definitely on the surface in the form of nanodots.

### Example 4

### Upgraded Chabazite

An aluminum enriched chabazite sample was prepared with a Si/Al ratio of about 1.2 and thoroughly silver exchanged as above. Ion exchange of sodium by silver on the enriched chabazite was complete as indicated by the absence of a sodium band on the XPS spectrum of the silver exchanged material. Both XPS and ICP-MS indicated a silver content in the range of 40-42 wt.% of the total sample. This is consistent with the ˜6.5 mequiv/g exchange capacity expected for this aluminum enriched chabazite analog.

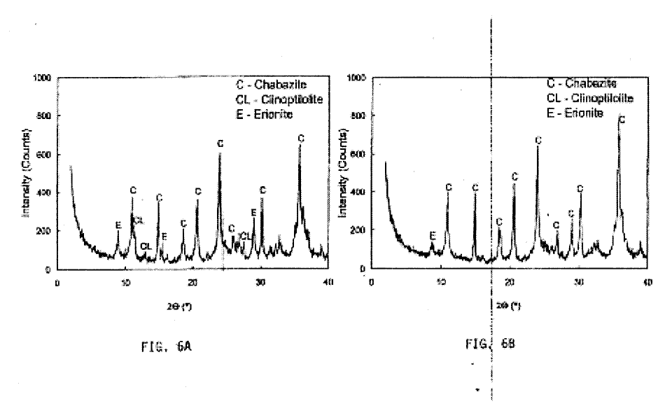

The upgraded chabazite described in Example 1 above appears to support higher concentrations of metal nanodots, as shown in FIGS. 5A and 5B. In FIG. 5A, silver nanodots on raw chabazite are shown. However, much higher concentrations of silver nanodots appear in FIG. 5B, where upgraded chabazite is used. A concentration of 48 nanoparticles per 1000 nm² was observed for the aluminum enriched material compared to 29 per 1000 nm² for the silver bearing raw ore. Also, there appears not to be larger pools of metal on the upgraded material as seen in the impure ore.

### Example 5

### Mercury Capture

The material's ability to capture HgO (elemental mercury) at elevated temperatures was tested. The only related work consists of room temperature studies on the effect of mercury adsorption on the optical properties of colloidal silver (Morris, 2002). The capture of elemental mercury from coal-fired power plant flue gas is extremely difficult via established methods, which are more suited to capture oxidized mercury species formed as flue gases cool from furnace temperatures (Brown, 1999; Hall, 1991; Miller, 2000). Embodiments of the present invention may permit interception of elemental mercury at realistic process gas temperatures (about 200-300° C.).

Elemental mercury (HgO) breakthrough studies were conducted by passing UHP Argon carrier gas at 40 ml/min through a 3 mm I.D. borosilicate glass chromatographic column. The column contained a 2 cm bed of the test sorbent, held in place with muffled quartz glass wool, and maintained at test temperature for the duration of the experiment. HgO vapour standards (50 μL) were injected by a syringe upstream of the sorbent column, and were quantified using standard temperature data. Any mercury breakthrough from the sorbent continued downstream to an amalgamation trap. The trap was thermally desorbed at appropriate intervals. Elemental mercury was detected by Cold Vapour Atomic Fluorescence Spectroscopy (Tekran). Data processing was conducted with Star Chromatography Workstation Ver. 5.5 (Varian, Inc.).

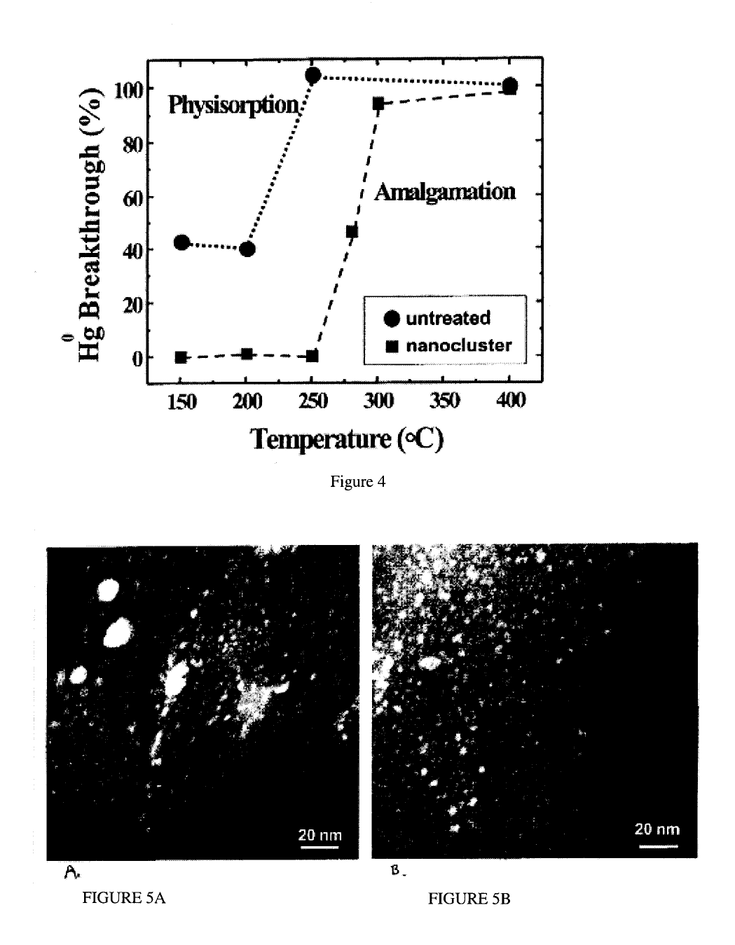

To test the mercury capture of chabazite supported nanodots, we injected mercury pulse exposures at much higher concentration (4 orders of magnitude) than those found in typical coal-fired power plant flue gases, which range from 1 to 10 μg/m (Callegari, 2003; Hall, 1991). FIG. 4 compares elemental mercury breakthrough using silver nanodot containing chabazite with the untreated chabazite, at various capture temperatures. For the case of nanodot-containing chabazite, breakthrough of elemental mercury is negligible up to capture temperatures of 250° C. Between 250° and 300° C., there was partial breakthrough of elemental mercury. Above 300° C., breakthrough becomes complete within 90 minute of release. At 400° C., release of elemental mercury occurred within 5 minutes of injection. Untreated chabazite, despite its open structure and known adsorption properties, was not an effective sorbent for elemental mercury. At 250° C., for example, the capture of elemental mercury on the untreated chabazite is negligible (FIG. 4). We emphasize that untreated chabazite has no significant capacity for HgO, exhibiting breakthrough at room temperature from a single injection (700 pg HgO), while more than 300 times this amount gave no breakthrough using nanodot-containing chabazite.

These results illustrate a different capture mechanism of elemental mercury for the two materials. Any capture of mercury on the untreated chabazite is mainly by physisorption, due to its high surface area. The capture mechanisms in the nanodot containing chabazite can be generally understood by considering the silver-mercury phase diagram (Massalski, 1990). The equilibrium bulk silver-mercury phase diagram contains a silver-mercury solid solution, where the solubility of mercury in silver remains nearly constant from room temperature (36 at. % Hg) to the formation of a liquid phase at 276° C. (37.3 at. % Hg). In the two phase field (liquid mercury and solid silver), there is a progressive decrease in the mercury solid-state solubility with increasing temperatures. There are also two intermetallic phases present at the higher mercury content, ξ and γ. During the capture experiments, the mercury diffuses into the silver nanodots, forming alloys and/or compounds. The very high surface to volume ratio of the silver particles will increase their chemical potential, and should enhance the rates of both alloying and intermetallic formation. However, near and above 276° C., mercury will begin to evaporate at an appreciable rate from the clusters, reducing and ultimately eliminating the capture ability of the sorbent.

It should be noted, however, that the equilibrium silver-mercury phase diagram does not strictly apply both due to the nano-scale of the silver clusters and because they contain small amounts of aluminum and iron. From “Pawlow Law”, one expects nanoscale clusters to melt at lower temperatures than their bulk counterparts, with the melting point scaling inversely with the cluster size (Pawlow, 1909), as is the general trend widely reported in literature. However, recent experimental (Breaux, 2005; Shvartsburg, 2000) and theoretical evidence (Mottet, 2005) indicates that in some cases the melting temperature of clusters composed of tens of atoms is actually higher than in the bulk. This phenomenon has been attributed this to a change in the character of the atomic bonding in the cluster relative to the bulk (Massalski, 1990; Pawlow, 1909), and to the effect of minor alloying additions (Mottet, 2005).

Further studies were conducted with the assistance of EPCOR at their G1/G2 Genesee Generating Station. These studies introduced sorbent samples into the flue gas ducts of an operating Rankine Cycle Coal Fired Electric Power Plant. As reviewed above (Pavlish 2005), this plant has been found to generate a high proportion of elemental mercury and only a minor amount of oxidized mercury in its flue gas emissions.

A wide range of potential sorbents were tested including bulk silver metal sputtered onto glass beads, Darco Norit FGL (FGL), Petroleum Coke (Pet Coke) carbon, nanosilver on raw chabazite (AgCh), nanosilver on upgraded chabazite (Up AgCh), nanosilver on high aluminum chabazite (HiAl AgCh) and nanopalladium chabazite (PdCh) were tested.

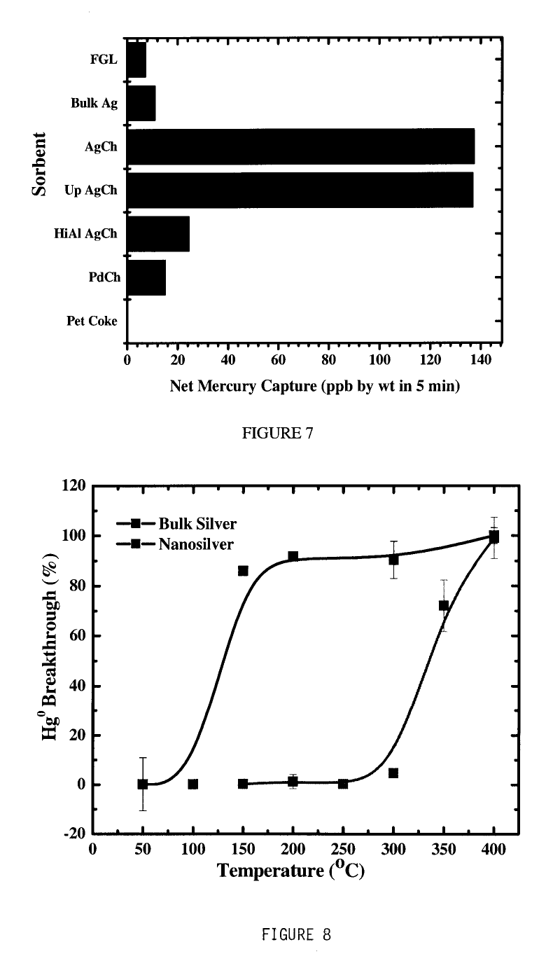

Each sorbent was split into two sub-samples, one field blank and one test sorbent. These were treated identically and the mercury content of the field blank subtracted from the test sorbent which had been placed into the flue gas streams for a period of 5 minutes. The results are presented as net mercury gain for each sorbent sample during the 5 minute exposure (FIG. 7).

FGL activated carbon and bulk silver metal gain only a small amount of mercury. Lab data suggest that the breakthrough temperature of bulk silver is very near the operating temperature of the flue gases in a power plant of this configuration (FIG. 8), and FGL is known to be a poor sorbent in streams which are dominated by elemental mercury. Pet Coke in its native form showed no capture of elemental mercury in actual flue gas conditions. Nanosilver on High Aluminum Chabazite and Nanopalladium chabazite showed small increases in total Hg above the previous two sorbents, following 5 minutes exposure in the same environment.

In striking contrast, Nanosilver chabazite in its raw (AgCh) and upgraded forms (Up AgCh) gave the best capture, and almost identical net gain in mercury (137.5;136.9 ppb/wt) in the 5 minute exposure. This was 18.8 fold the gain shown by FGL in the same period.

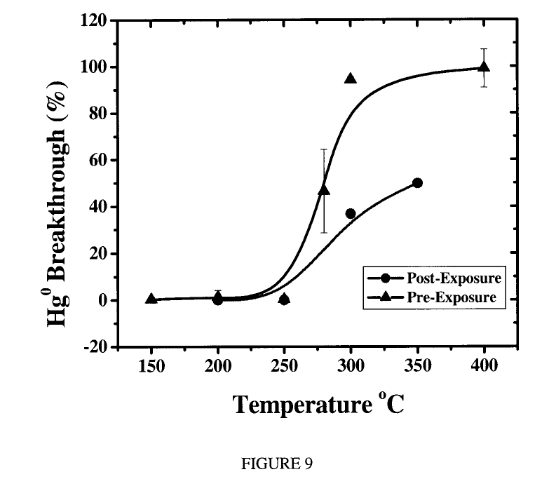

Furthermore lab tests on the exposed nanosilver chabazite (raw form) showed the subsequent breakthrough temperature for further elemental mercury capture had not been degraded at the operating temperature of Rankine cycle power plant flue gases, and in fact may have been enhanced at higher temperatures (FIG. 9). Accordingly, the silver nanodot material may be reusable, something which can be accomplished easily by making a magnetic composite of this sorbent. Reusing this material can recover the cost differential and the mercury can be separated in a simple recycling process. This magnetic separation of a recyclable sorbent also protects the valuable fly ash stream (and associated carbon credits) and meets two major goals of environmental projects as defined by US Superfund criteria, minimization of waste volume and reduction of environmental mobility of a toxin.

### References

The following references are referred to by name above, and, where permitted, the contents of these references are incorporated herein as if reproduced in their entirety.
Ackley, M. W., Rege, S. U. and Saxena, H., Micropor. and Mesopor. Mat., 2003, Application of natural zeolites in the purification and separation of gases, 61, 25.
Baerlocher, W Ch. M., Meier, D W. H. M., Olson, D. H., Atlas of Zeolite Framework Types, fifth rev. ed., Elsevier, Amsterdam, 2001.
Breaux, G. A., Neal, C. M., Cao, B., Jarrold, M. F., Phys. Rev. Lett. 2005, Melting, Premelting, and Structural Transitions in Size-Selected Aluminum Clusters with around 55 Atoms, 94, 173401.
Breck, D. W. Breck, Zeolite Molecular Sieves, John Wiley, New York, 1974.
Brown, T. D., D. N. Smith, R. A. Hargis Jr. and W. O'Dowd. 1999. Mercury measurement and its control: What we know, have learned and need to further investigate. Journal of Air & Waste Management. Vol. 49. pg. 628-640.
Bruhweiler, D. and Galzaferri. G., Micropor. Mesopor. Mat., 2004, Molecular sieves as host materials for supramolecular organization, 72, 1.
Callegari, A., D. Tonti, M. Chergui, Nano Lett. 2003, Photochemically Grown Silver Nanoparticles with Wavelength-Controlled Size and Shape, 3, 1565.
Carvill, B. T., Lemer, B. A., Adelman, B. J., Tomczak, D. C., Sachtler, W. M. H., J. Catalysis, 1993, Increased Catalytic Activity Caused by Local Destruction of Linear Zeolite Channels: Effect of Reduction Temperature on Heptane Conversion over Platinum Supported in H-Mordenite, 144, 1-8.
Crock, J. G., 2005, Determination of total mercury in biological and geological samples: U.S.G.S. Open File Report 2005-1030, web version only at http:!!pubs.usgs.gov of!2005!1030!
Durham, M. D., Bustard, C. J., Schlager, R., Martin, C., and Jolmson, 5., 2001, Field test program to develop comprehensive design, operating and cost data for mercury control systems on non-scmbbed coal-fired boilers, Presented at the Air & Waste Mangement Association 94th Annual Meeting and Exhibition, June 24-28, Orlando, Fla. U.S.A.
Erickson, B. E., 2002, Regenerating mercury loaded sorbents, Environ. Sci. Tech., 36, 408A.
Granite, E. J., Pemiline, H. W., and Hargis, R. A., 2000, Novel sorbents for mercury removal from flue gas, md. Eng. Chem. Res., 39, 1020-1029.
Hall, B., P. Schager and O. Lindqvist, Water, Air Soil Pollut., 1991, Chemical reactions of mercury in combustion flue gases, 56, 3.
Hayhurst, D. T., in Sand, L. B., Mumpton, F. A. (Eds.), Natural Zeolites: Occurrence, Properties, Use Permagon Press, 1978, 503.
Holmes, M. and J. Pavlish. 2004. Mercury information clearinghouse:Quarterly 1—Sorbent injection technologies for mercury control. U.S.D.O.E. #DE-FC26-98FT40321. http://www.ceamercuryprogram.ca.21p.
Kuznicki, S. M. and Whyte, Jr., J. R. (1988). Ion-exchange agent and use thereof in extracting heavy metals from aqueous solutions. U.S. Pat. No. 5,071,804.
Kuznicki, S. M. and Whyte, Jr., J. R. (1991). Ion-exchange agent and use thereof in extracting heavy metals from aqueous solutions. U.S. Pat. No. 5,223,022.
Kuznicki, et al. U.S. Provisional Patent Application No. 60/869,474.
Kuznicki, et al., U.S. patent application Ser. No. 11/777,804.
Lewis, L. N., Chem. Rev., 1993, Chemical catalysis by colloids and clusters, 93, 2693.
Massalski, T. B. Binary Phase Diagrams Vol 1, (ed. T. B. Massalski), ASM International, Materials Park, Ohio, 1990, 43.
Metraux, G. S. and Mirkin, C. A., Adv. Mater. 2005, Rapid Thermal Synthesis of Silver Nanoprisms with Chemically Tailorable Thickness, 17, 412.
Miller, S. J., Dunham, G. E., Olson, E S., and Brown, T. D., 2000, Flue gas effects on a carbon-based mercury sorbent, Fuel Proc. Technol., 66, 343-363.
Miller, B. G., 2005, Coal Energy Systems, Elsevier Academic Press, London, 370.
Mondale, K. D., Carland, R. M. and Aplan, F. F., Min. Eng., 1995, The comparative ion exchange capacities of natural sedimentary and synthetic zeolites, 8, 535.
Morris, T., Copeland, McLinden, H., E., Wilson, S. and Szulczewski, G., Langmuir, 2002, The Effects of Mercury Adsorption on the Optical Response of Size-Selected Gold and Silver Nanoparticles, 18, 7261.
Mottet, C., Rossi, G., Baletto, F., Ferrando, R., Phys. Rev. Lett., 2005, Single Impurity Effect on the Melting of Nanoclusters, 95, 035501.
Nelson, S. Jr., Landreth, S., R., Zhou, Q. and Miller, J., 2004, Accumulated power-plant mercury-removal experience with brominated PAC injection, 4th DOE-EPRI-U.S.EPA-AWMA Combined Power Plant Air Pollutant Control “Mega” Symposium, Washington, D.C., Aug. 30-Sep. 2, 2004.
Nelson, S. G. Jr., 2005. Sorbents and methods for the removal of mercury from combustion gases. U.S. Pat. No. 6,953,494.
Pawlow, P., Z. Phys. Chem. (Leipig), 1909, 65, 1.
Pavlish, J. H., Laudal, D. L., Holmes, M. J., Hamre, L. L., Musich, M. A., Pavlish, B. M., Weber, G. F. and Hajicek, D. R., 2005, Technical review of mercury technology options for Canadian Utilities—A report to the Canadian Council of Ministers of the Environment, 2005-EERC-03-07, Mar. 22, 2005
Seidel, A., Loos, J., Boddenberg, B., J. Mater. Chem., 1999, Copper nanoparticles in zeolite Y, 9, 2495-2498.
Senior, C. L. and S. A. Johnson. 2005. Impact of carbon-in-ash on mercury removal across particulate control devices in coal-fired power plants. Energy & Fuels, Vol. 19. pg. 859-863.
Shvartsburg, A. A. and Jarrold, M. F., Phys. Rev. Lett., 2000, Solid Clusters above the Bulk Melting Point, 85, 2530.
Sobral, L. G. S., Santos, R. L. C. and Barbosa, L. A. D., 2000, Electrolytic treatment of mercury-loaded activated carbon from a gas cleaning system, Sci. Total Environ., 261, 195-201.
Vidic, R. D. and D. P. Siler. 2001. Vapour phase elemental mercury adsorption by activated carbon impregnated with chloride and chelating agents. Carbon. Vol. 39. pg. 3-14.

What is claimed is:

1. A method of adsorbing mercury from an industrial process emission, such as a coal-fired plant, comprising the step of contacting the emission with a mercury sorbent comprising a plurality of metal nanodots formed on chabazite.

2. The method of claim 1 wherein the metal nanodot comprises a silver nanodot.

3. The method of claim 2 wherein the chabazite has a gross plating morphology or exterior surface area of at least about 5 m² per gram.

4. The method of claim 3 wherein the chabazite has an exterior surface area of at least about 10 m² per gram.

5. The method of claim 4 wherein the chabazite has an exterior surface area of at least about 15 m² per gram.

6. The method of claim 1, wherein the industrial process emission comprises a flue gas.

7. The method of claim 6 wherein the flue gas is the result of coal oxidation or combustion.

8. A mercury sorbent comprising a plurality of metal nanodots formed on chabazite.

9. The sorbent of claim 8 wherein the metal comprises silver.

10. The sorbent of claim 9 wherein the chabazite has a gross plating morphology or exterior surface area of at least about 5 m² per gram.

11. The sorbent of claim 10 wherein the chabazite has an exterior surface area of at least about 10 m² per gram.

12. The sorbent of claim 11 wherein the chabazite has an exterior surface area of at least about 15 m² per gram.

13. The sorbent of claim 8 wherein the metal nanodots comprise surface-accessible metal nanodots, having a particle size less than about 100 nm.

14. The sorbent of claim 13 wherein the nanodots have a particle size less than about 50 nm.

15. The sorbent of claim 14 wherein the nanodots have a particle size less than about 30 nm.

16. The sorbent of claim 15 wherein the nanodots have a particle size less than about 20 nm.

17. The sorbent of claim 16 wherein the nanodots have a particle size less than about 10 nm.

18. The sorbent of claim 8 wherein the chabazite comprises mineral chabazite having a Si/Al ratio of less than about 3.5.
